(19) United States
(12) Patent Application Publication
(10) Pub. No.: US 2010/0321621 A1
(43) Pub. Date: Dec. 23, 2010

(54) DISPLAY DEVICE

(76) Inventors: Ryo Kikuchi, Osaka (JP); Hiroshi Fukushima, Osaka (JP); Tomoo Takatani, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/744,823

(22) PCT Filed: Sep. 3, 2008
(86) PCT No.: PCT/JP2008/065885

§ 371 Date: May 26, 2010

(30) Foreign Application Priority Data
Nov. 29, 2007 (JP) 2007-308656

(51) Int. Cl. G02F 1/1333

(52) U.S. Cl. 349/122

(57) ABSTRACT

The present invention provides a thin-profile and light-weight display device capable of improving display qualities and suppressing incorrect operation.

The present invention is a display device displaying images different depending on viewing directions simultaneously and detecting a position of a contact point on a display screen,
the display device including:
an image-displaying member displaying the images;
a parallax-creating member arranged on a front face side of the image-displaying member; and
a transparent electrode for detecting the position of the contact point,
wherein the parallax-creating member includes a substrate and a parallax element formed on the substrate,
the parallax element creating parallax in each of the viewing directions, and
the transparent electrode is formed on the substrate

### TECHNICAL FIELD

The present invention is directed to display devices. More particularly, the present invention is directed to a multiple image display device with screen input function capable of displaying different images depending on viewing points and further detecting a point of contact by pen, finger, and the like on a display screen.

### BACKGROUND ART

Multiple image display devices with screen input function capable of detecting a contact point of pen touch, finger touch, and the like, on a display screen are now being widely used. Touch panels, touch sensors, and the like are being commonly used as such a detector. For example, if a display device is integrated with a touch panel, the touch panel is arranged on a front face side of an image-displaying member such as a liquid crystal display (LCD) panel.

Electrostatic capacity coupling type, resist film type, infrared type, ultrasonic electromagnetic induction/coupling type touch panels are known. Particularly if an electrostatic capacity coupling type touch panel is used with a display device, a reduction in display qualities can be relatively suppressed even if the panel is arranged on a display screen.

FIGS. 7(a) and 7(b) are cross-sectional views each schematically showing a structure of a conventional electrostatic capacity coupling type touch panel. A conventional electrostatic capacity coupling type touch panel 180 has a structure in which a transparent electrode 131 is disposed on a glass substrate 121 as shown in FIG. 7(a) or a structure in which a transparent electrode 131 is disposed between two glass substrates 121a and 121b as shown in FIG. 7(b). This structure enables the touch panel 180 to detect a finger 181 touch position, for example.

Multiple image display devices capable of displaying images different from one viewing angle to another have been recently known. For example, Patent Document 1 discloses a dual view display capable of displaying two different images, a right image and a left image, on the same screen, as such a multiple image display device.

Further, multiple image display devices with screen input function capable of displaying images different from one viewing direction to another and further detecting a contact point of pen touch, finger touch, and the like, on a display screen are now spreading.

Below given is a structure of a conventional multiple image display device with screen input function, e.g., a dual view LCD device including an electrostatic capacity coupling type touch panel. FIGS. 8(a) and 8(b) are cross-sectional views each schematically showing a structure of a conventional dual view LCD device including an electrostatic capacity coupling type touch panel. Referring to FIG. 8(a), a conventional dual view LCD device 200 has a structure in which an electrostatic capacity coupling type touch panel 180 is arranged on the front face side of a dual view LCD panel 101 with an air layer therebetween. The panel 101 includes an LCD panel 110 as an image-displaying member and a parallax barrier 120 as a parallax-creating member, and front and back polarizers 114 and 115. On the back face side of the panel 101, a backlight 150 is arranged. Further, a barrier 122 composed of a light-shielding slit is formed as a parallax element in the parallax barrier 120.

Patent Document 2, for example, discloses a technology of using a first transparent electrode film, which is a viewing angle control component constituting an LC display part, as an electrostatic capacity coupling type touch panel.

Patent Document 3, for example, discloses an electrostatic capacity type touch panel device in which an identical electrode is used for a display and for a touch panel.

With respect to electrostatic capacity coupling type touch panels, Patent Document 4 discloses a technology of attaching a touch face of a first transparent substrate on which a transparent conductive film for contact detection is arranged to an anti-glare second transparent substrate with a transparent adhesive therebetween.

### [Patent Document 1]

WO 2006/100904

### [Patent Document 1]

WO 2006/030745

### [Patent Document 1]

Japanese Kokai Publication No. 2003-99192

### [Patent Document 1]

Japanese Kokai Publication No. H-05-324203

### DISCLOSURE OF INVENTION

The conventional dual view LCD device 200 has room for improvement in a reduction in its thickness and weight because the touch panel 180 increases the thickness and weight of the module.

Further, as shown in FIG. 8(b), the air layer between the panels 101 and 180 causes unnecessary reflection of transmission light 172 and ambient light 171, leading to a reduction in transmittance. So the LCD device 200 also has room for improvement in display qualities even if including the panel 180.

According to the LCD device 200, when a user contacts the panel 180 with viewing it from a direction oblique to the screen, undesirable processing might be executed. So the LCD device 200 also has room for improvement in suppression of incorrect operation. This is not caused when a transparent electrode film that is a viewing angle control component of a switching LC display portion is used as an electrostatic capacity coupling type touch panel as in the display device in Patent Document 2.

The present invention has been made in view of the above-mentioned state of the art. The present invention has an object to provide a thin-profile and light-weight display device capable of improving display qualities and suppressing incorrect operation.

The present inventors made various investigations on thin-profile and light-weight display devices capable of improving display qualities and suppressing incorrect operation. The inventors noted an arrangement position of a transparent electrode for detecting a contact point. Then, the inventors found that if, in a multiple image display device including an image-displaying member, a parallax-creating member, and a transparent electrode for detecting a position of a contact point, the parallax-creating member includes a substrate and a parallax element formed on the substrate, the parallax element creating parallax in each of the viewing directions, and the transparent electrode is formed on the substrate, a touch panel does not need to be independently arranged on a front face side of the display device. Further, the air layer, which is conventionally present between a parallax-creating member and a touch panel, does not exist, and in addition, the transparent electrode can be located closer to the parallax element, and a distance from the transparent electrode and the contact surface can be more decreased, compared to the conventional configuration. As a result, the above-mentioned problems have been admirably solved, leading to completion of the present invention.

The present invention is a display device displaying images different depending on viewing directions simultaneously and detecting a position of a contact point on a display screen,

the display device including:

an image-displaying member displaying the images;

a parallax-creating member arranged on a front face side of the image-displaying member; and

a transparent electrode for detecting the position of the contact point,

wherein the parallax-creating member includes a substrate and a parallax element formed on the substrate,

the parallax element creating parallax in each of the viewing directions, and

the transparent electrode is formed on the substrate.

According to this, the display device of the present invention can function as a display device including a parallax-creating member with touch panel function, specifically, as a multiple image display device with screen input function. The “touch panel function” means a function of conducting desired various functions just by contact of pen, finger, or the like touch on a display screen.

The display device of the present invention allows its reduction in thickness and weight because the need of arranging a touch panel independently on the front side of the display device is obviated.

The display device of the present invention can show improved display qualities because the air layer, which exists between the parallax-creating member and the touch panel in conventional multiple image display devices with screen input function, does not exist, and therefore, unnecessary reflection of ambient light and transmission light is not caused.

According to the display device of the present invention, the transparent electrode can be disposed closer to the parallax element, thereby decreasing a distance between the transparent electrode and the contact surface, compared with the case where a touch panel is independently arranged on the front face side of a display device as in conventional multiple image display devices with screen input function. So when an image is viewed from an oblique direction to a display screen, a difference in position between a viewed image and a contact point can be minimized. As a result, incorrect operation due to this difference can be suppressed.

Compared with the case where a touch panel is independently arranged on the front face side of the display device, the number of components (for example, touch panel substrate) can be reduced, resulting in reduction in costs of the display device of the present invention.

In this description, the “front face side” means a display face side or an observer side, and the “back face side” means a side opposite thereto.

The configuration of the display device of the present invention is not especially limited. The display device may or may not include other components as long as it essentially includes the above-mentioned components.

Preferable embodiments of the display device of the present invention are mentioned below in detail. The following various embodiments may be appropriately used in combination.

The above-mentioned image-displaying member is not especially limited as long as it can display images. Various display device may be used. LCD panels and organic EL panels are particularly preferably used.

The above-mentioned transparent electrode may be arranged on the front face side of the substrate. According to this, the distance between the transparent electrode and the contact point can be decreased, thereby improving sensitivity of the touch sensor.

The transparent electrode and the parallax element may be arranged on the same main surface side of the substrate. This configuration is advantageous in productivity because the parallax-creating member can be completed by treatment for only one surface of the substrate.

If the transparent electrode and the parallax element are arranged on the same main surface side of the substrate, the parallax-creating member may be a parallax barrier including a barrier composed of a light-shielding slit as the parallax element, and the transparent electrode may be arranged on a substrate side of the barrier. This can suppress disconnection of the transparent electrode at a shoulder portion of the barrier, and so conduction defects of the transparent electrode can be suppressed. Further, the display device of the present invention can be easily provided.

An end of the transparent electrode may extend beyond an end of the display region at least in each of the viewing directions (hereinafter, also referred to as a “first embodiment”). Conventional display devices with screen input function are designed for input operation from the front of a display region (display screen). So a configuration in which a transparent electrode of a touch panel is arranged in the display region presents no problem in such conventional devices. However, if such a configuration is applied to the display device of the present invention that is designed also for detecting a position of a contact point when viewed from a direction oblique to the display screen, a contact point at an edge of the display region might not be detected because the transparent electrode is not extended up to the edge. According to the first embodiment, the transparent electrode is arranged beyond the end of the display screen, and so even when a user touches an outermost edge of the screen with viewing an image from a direction oblique to the display screen, the contact point can be detected. Specifically, touch input is available on the entire surface in the display region in each of the viewing (observation) directions.

In the first embodiment, it is preferable that the image-displaying member is a liquid crystal display panel including a pair of substrates and a liquid crystal layer interposed therebetween,

the display device includes a front polarizer arranged on the front face side of the parallax-creating member, and

the front polarizer is arranged to cover the transparent electrode. According to this, this dual view LCD device can provide proper images by LC display and detect the contact point on the entire surface in the display region in each of the viewing (observation) directions.

In order to easily produce the display device of the present invention, it is preferable that the parallax-creating member a parallax barrier including a barrier composed of a light-shielding slit as the parallax element, and the barrier is arranged on a back face side of the substrate.

### EFFECT OF THE INVENTION

The display device of the present invention is a thin-profile and light-weight display device capable of improving display qualities and suppressing incorrect operation.

### BEST MODES FOR CARRYING OUT THE INVENTION

The present invention is mentioned in more detail with reference to the drawings showing embodiments of the present invention but not limited thereto.

### Embodiment 1

FIG. 1 is a cross-sectional view schematically showing a display device of Embodiment 1.

A display device 100 of the present Embodiment has a structure in which a front polarizer 14 arranged on the front side-outermost face of the device 100, a parallax barrier 20 as a parallax-creating member, an LC display panel 10 as an image-displaying member, and a back polarizer 15 are stacked in this order. A backlight 50 is arranged on the back face side of the back polarizer 15.

The parallax barrier 20 and the panel 10 are attached to each other with the adhesive 40 therebetween. The front and back polarizers 14 and 15 are attached to the parallax barrier 20 and the LCD panel 10, respectively with an adhesive (not shown) therebetween.

The adhesive 40 is a thermosetting and/or UV curable resin adhesive and disposed on the substantially entire surface of the barrier 20 and panel 10 to attach the two to each other.

The front polarizer 14 and the back polarizer 15 are so configured that a polarizer made of a PVA (polyvinyl alcohol)-iodine complex or PVA-dichroism pigment film is interposed between protective layers made of a cellulose resin such as triacetyl cellulose (TAC). A viewing angle compensation film such as a retarder may be arranged on inner sides of the front and back polarizers 14 and 15. The front and back polarizers 14 and 15 are arranged so that their absorption axes are substantially perpendicular or parallel to each other when the display surface is viewed in plane.

The LCD panel 10 includes a pair of substrates, a TFT (thin film transistor) array substrate 11 and a CF (color filter) substrate 12, and a liquid crystal (LC) layer 13 interposed therebetween. The LC layer 13 is in a space defined by a sealing member (not shown) arranged in the periphery of a region where the TFT array substrate 11 overlaps with the CF substrate 12. The sealing member is arranged in a frame region having no contribution to display, which is around a display region where images are displayed. The materials for the sealing member and the LC layer 13 are not especially limited and may be appropriately determined.

The TFT array substrate 11 includes, on the LC layer 13 side of a transparent and colorless insulating substrate such as a glass substrate and a resin (plastic) substrate, TFTs as pixel switching elements, pixel electrodes, bus lines such as data lines and scanning lines, and alignment films, as components of a display element of the panel 10. Thus, the panel 10 is an active matrix LCD panel including pixels arranged in a matrix pattern.

The CF substrate 12 is a counter substrate and includes black matrix (BM), color filters of red, blue, and green, common electrodes, alignment films, and the like on the LC layer 13 side of a transparent and colorless insulating substrate such as a glass substrate and a resin (plastic) substrate.

FIG. 2 is a plan view schematically showing an LCD panel of Embodiment 1.

The TFT array substrate 11 has an extended portion, which is extended from the CF substrate 12. In this extended portion, a source driver 16 and a gate driver 17 where a driving circuit for driving the TFTs and supplying charges in a desirable amount to the pixel electrodes, are arranged. Further, an end of the extended portion where the source driver 16 is arranged is provided with terminals, and thereto, a FPC board 18 for LC driving, equipped with a control driver and the like, is connected. The source driver 16 is connected to a source electrode of the TFT through the data line. The gate driver 17 is connected to a gate electrode of the TFT through the scanning line. Transistors constituting the source driver 16 and the gate driver 17 may be monolithically formed to be the same as the TFT for pixel driving arranged in the display region. In this case, it is preferable that both the TFTs in the driving circuit and the TFTs for pixel driving are TFTs including a polycrystalline silicon film (preferably, CGS (continuous grain silicon) film) so that the operation speed of the driving circuit is increased.

To the LC layer 13 in each pixel region, a desired voltage is applied by the common electrode of the CF substrate 12 and the pixel electrode of the TFT array substrate. This voltage application changes alignment directions of the LC molecules, which enables the device 100 to modulate light from the backlight 50.

The parallax barrier 20 has a function of splitting transmission light into two in right and left directions as the display screen is viewed from the front to create parallax in each of the viewing directions. More specifically, the parallax barrier 20 includes: a transparent and colorless insulating substrate 21 such as a glass substrate and a resin (plastic) substrate; and barriers 22 as parallax elements, formed in a stripe pattern on the back face side of the substrate 21. The barriers 22 are light-shielding slits formed in the column direction of the pixels (or sub-pixels in color display). According to the LCD panel 10, pixels giving a right display image and pixels giving a left display image are adjacently arranged with the corresponding barrier 22 thereabove on a column-to-column basis. As a result, the display device 100 of the present embodiment can provide the right display image as viewed from the right direction and the left display image as viewed from the left direction. Specifically, the display 100 is a dual view LCD device. The display device 100 may display a single and the same image in any viewing directions. Thus, the display device 100 displays discrete images to right and left directions in dual view mode and displays a single image in any viewing directions in single view mode.

On the front face side of the insulating substrate 21, a transparent electrode (conductive film for detecting contact position), which is a transparent conductive film, is arranged. Further, a protective film 32 made of an inorganic insulating material is arranged on the front face side of the electrode 31 for insulation and anti-corrosion thereof. The transparent electrode 31 detects a contact point on the display screen.

Thus, the display device 100 of the present Embodiment functions as a multiple image display device and is further provided with touch panel function. Specifically, the display device 100 of the present Embodiment is a multiple image display device with screen input function.

The barrier 22 and the transparent electrode 31 are arranged in the common insulating substrate 21, and specifically, the transparent electrode 31 is arranged in the parallax barrier 20. The increase in module thickness, which is caused when the display device 100 is provided with touch panel function, can be substantially prevented, and the increase in module weight can also be effectively suppressed.

Further, the air layer, which is present between the parallax barrier and the touch panel in the conventional display device including the touch panel independently arranged on a front face side of the display device, does not exist. Thus, the absence of such an air layer suppresses unnecessary reflection of the transmission light 72 and the ambient light 71 between the barrier 22 and the transparent electrode 31 shown in FIG. 1. As a result, the transmittance can be increased.

Compared with such conventional display devices including a touch panel independently arranged on the front side thereof, the distance from the barrier 22 and the transparent electrode 31 can be decreased, thereby reducing the distance from the transparent electrode 31 and the contact surface (the front polarizer 14 surface of the present Embodiment). So when the display screen is viewed in the left or right direction (e.g., a direction at 30° from the normal direction of the display screen) in dual view mode, a difference between an observed image position and a contact point can be minimized. As a result, incorrect of operation due to this difference can be suppressed.

Further, the number of components (for example, touch panel substrate) can be decreased, leading to a reduction in production costs compared with the conventional display devices.

FIG. 3 is a plan view schematically showing a configuration on the front face side of the parallax barrier of Embodiment 1.

On the front face side of the insulating substrate 21 of the parallax barrier 20, four touch panel wirings 33a, 33b, 33c, and 33d are formed around the transparent electrode 31 to be connected thereto at four corners thereof. The touch panel wirings 33a, 33b, 33c, and 33d are connected to a FPC board 34 for touch panel driving including a contact point detection circuit. An alternating voltage is applied to the wirings 33a, 33b, 33c, and 33d to form a low-gradient electric field substantially uniformly in the transparent electrode 31. By pen touch, finger touch, and the like on the front polarizer 14 (or another insulating member formed thereon) surface, the transparent electrode 31 is capacitively coupled to ground. This capacity is a sum of a capacity between the front polarizer 14 and the transparent electrode 31 and a capacity between a user and ground. The electric resistance value between the capacitively coupled contact point and the transparent electrode 31-wiring 33a, 33b, 33c, or 33d contact point is proportional to a distance therebetween. Thus, currents proportional to the distances flow through the wirings 33a to 33d. By measuring the currents, coordinate of the contact point can be determined.

Thus, the display device 100 is configured to have the electrostatic capacity coupling type touch panel configuration and the parallax barrier 20, so the device 100 can detect the contact point while displaying different images in each of the viewing directions. According to the display device 100, the pixel electrode for LC driving and the transparent electrodes 31 for touch panel can be separately driven, so the contact point can be detected like in the conventional display device including a touch panel independently arranged on the front face thereof. Specifically, according to the display device 100 of the present Embodiment, the contact point can be detected on the same principle as in common electrostatic capacity coupling system.

The wiring design is not especially limited as long as the respective wirings 33a, 33b, 33c, and 33d are connected to the transparent electrode 31 at the four corners thereof. The respective wirings 33a, 33b, 33c, and 33d are preferably arranged to be symmetry in the vertical or transverse direction as shown in FIG. 3, and more preferably in the vertical and transverse directions when viewed in front. This allows more easy adjustment of the touch panel. As an example of hardware adjustment, the resistance values of the respective wirings 33a, 33b, 33c, and 33d may be adjusted to be uniform. As an example of software adjustment, coordinate correction values may be calculated to correct coordinate distortion or sensitivity. If wirings drawn from the respective wirings 33a, 33b, 33c, and 33d are so designed as to be asymmetry, the adjustment for touch panel needs to be performed on each wiring basis.

FIG. 4 is a plan view schematically showing a configuration near a corner of the display device of Embodiment 1.

If the touch panel is touched in the front of the display device 100, it would be enough that the transparent electrode 31 region is coincident with the display region 19. In dual view mode, if the touch panel is touched from an oblique direction (e.g., a direction at 30° with respect to the normal direction of the display screen), the contact face (the front polarizer 14 surface in the present Embodiment) makes an angle with the transparent electrode 31. In such a case, preferably, the transparent electrode 31 is so designed that the touch panel function works correctly. Specifically, the transparent electrode 31 region is coincident with or more preferably larger than the display region 19 as shown in FIG. 4. The transparent electrode 31 region varies with the distance from the CF substrate 12 thereto. More specifically, for example, the end of the transparent electrode 31 extends beyond the end of the display region 19 by 0.1 mm (more preferably 1.5 mm) or larger at least in the viewing direction (transverse direction).

In the conventional display device with screen input function that is designed for input operation from the front of the display region, it would be enough that the transparent electrode for detecting the contact point is arranged in the display region, but this does not apply to the display device 100 of the present Embodiment where the contact point needs to be detected with an image observed from an oblique direction to the display screen. In the case where the transparent electrode 31 is arranged to cover only the display region 19, if the contact point is at an edge of the display region, which is free from the transparent electrode, the contact portion might not be correctly detected. As mentioned above, by arranging the transparent electrode 31 so that the edge thereof extends beyond the end of the display region 19 at least in the viewing direction, the contact point at the outermost edge of the display region 19 can be detected when an image is observed from a direction oblique to the display face. Specifically, touch input is available over the entire surface in the display region 19 in each of the viewing (observation) directions.

The transparent electrode 31 is arranged within the front polarizer 14 when the display screen is viewed in plane. Thus, the front polarizer 14 is arranged to cover the transparent electrode 31 region. As a result, a proper image is displayed by LC display and simultaneously a contact point can be detected over the entire surface in the display region in each of the viewing (observation) directions.

A production method of the display device of the present Embodiment is mentioned below. FIGS. 5-1(a) to 5-1(d) are cross-sectional views schematically showing the display device of Embodiment 1 in first production steps. FIGS. 5-2(e) to 5-2(g) are cross-sectional views schematically showing the display device of Embodiment 1 in second production steps. FIGS. 5-3(h) to 5-3(i) are cross-sectional views schematically showing the display device of Embodiment 1 in third production steps. In FIG. 5-1(b), the reference number 33 shows any one of the touch panel wirings 33a, 33b, 33c, and 33d.

Referring to FIG. 5-1(a), the transparent electrode 31 is formed as follows. A high-resistant transparent conductive film (e.g., ITO) is first sputtered on one main surface of a transparent and colorless insulating substrate 21 such as a glass substrate and a resin (plastic) substrate through a mask for deposition 61a. The transparent electrode 31 is preferably formed to have a thickness of about 10 nm to 30 nm (e.g., 15 nm) and have a resistance of about 500Ω/□ to 20000Ω/□ (e.g., 1000Ω/□). The transparent electrode 31 may be formed by forming a transparent conductive film over the entire surface of the insulating substrate 21 and then patterning the film by photolithography.

Now referring to FIG. 5-1(b), a low-resistant metal film (e.g., aluminum) is sputtered on the insulating substrate 21 and the transparent electrode 31 through a mask for deposition 61b. As a result of this, the touch panel wirings 33a, 33b, 33c, and 33d, and a terminal portion 35 to which the FPC board 34 is connected are formed. The touch panel wirings 33a to 33d and the terminal portion 35 are preferably formed to have a thickness of about 50 nm to 500 nm (e.g., 100 nm) and have a resistance of about 0.1Ω/□ to 10Ω/□ (e.g., 4Ω/□). The touch panel wirings 33a to 33d and the terminal portion 35 may be formed by forming a metal film over the entire surface of the insulating substrate 21 and then patterning the film by photolithography.

As shown in FIG. 5-1(c), the protective film 32 is formed in the following manner to protect the high-resistant transparent conductive film and the low-resistant metal film against corrosion. An inorganic insulating film (for example, silicon oxide film such as SiO₂ film) is formed on the insulating substrate 21, the transparent electrode 31, and the touch panel wirings 33a to 33d, i.e., in a region except for the terminal portion 35, by sputtering through a mask 61c for deposition. The protective film 32 is preferably formed to have a thickness of about 100 nm to 1000 nm (e.g., 100 nm).

A film (not shown) such as a transparent protective film may be attached to the main surface where the transparent electrode 31 is formed of the insulating substrate 21 in order to protect the transparent electrode 31 with more certainty in the subsequent steps until the attachment of the front polarizer 14.

Now referring to FIG. 5-1(d), a black photosensitive (preferably, UV-curable) resin film 23 for barrier 22 is spin-coated on the other main surface of the insulating substrate 21. The resin film, 23 is preferably formed to have a thickness of about 0.1 μm to 6 μm (e.g., 4 μm) and have an OD value of 3 or larger (e.g., 4). As the resin film 23, a film-like resin may be laminated on the other main surface of the insulating substrate 21.

As shown in FIG. 5-2(e), the resin film 23 is exposed to light such as UV ray 73 through a photomask 62 with a desired pattern and then developed to give the barrier 22.

The width and pitch of the barrier 22 may be appropriately determined in accordance with those of the pixel. For example, the pitch and width of the barrier 22 are about 120 μm and 80 μm respectively when those of the pixel (sub-pixel in color display) are 65 μm and 40 μm, respectively.

Then, referring to FIG. 5-2(f), the FPC board 34 for touch panel driving is bonded to the terminal portion 35 by thermal compression through an anisotropic conductive film (ACF, not shown), thereby connecting the FPC board 34 to the wirings 33a to 33d.

Then, as shown in FIG. 5-2(g), an adhesive 40 (e.g., a thermosetting and/or UV-curable resin adhesive, preferably UV-curable resin adhesive) is applied on the insulating substrate 21 and the barrier 22 with a slit coater. The adhesive 40 is preferably formed to have a thickness of about 10 μm to 50 μm (e.g., 30 μm). The adhesive 40 preferably contains a resin. Resins typically show a light transmittance higher than that of air. So the adhesive 40 mainly contains a resin, which leads to an increase in transmittance of the display device 100.

The cured adhesive 40 is transparent and colorless. So an observer can more clearly recognize images displayed on the panel 10.

The cured adhesive 40 preferably has a refractive index (about 1.5) equivalent to those of the insulating substrate 21 of the parallax barrier 20 and the insulating substrate constituting the CF substrate of the panel 10. As a result, reflection of light at interfaces between the adhesive 40 and the panel 10 and between the adhesive 40 and the parallax barrier 20 can be more effectively suppressed. Thus, the transmittance can be more increased, and the reduction in contrast attributed to unnecessary reflection of ambient light can be more effectively suppressed.

The cured adhesive 40 preferably has a storage elastic modulus of 1.0×10³ to 1.0×10⁶ Pa at 23° C. When the adhesive 40 that contains a resin is cured, curing shrinkage is uneven between the outer circumference and the center of the adhesive 40, and internal stress easy occurs in the adhesive 40. This affects the cell thickness of the panel 10, which possibly causes display unevenness at an end of the display region. When the adhesive 40 has the above-mentioned storage elastic modulus, the internal stress can be effectively absorbed by the elasticity of the adhesive 40 itself. Thus, display qualities of the display device 100 can be improved.

Referring to FIG. 5-3(h), the parallax barrier 20 with the transparent electrode 31 is attached to the LCD panel 10, which is produced separately from the barrier 20, with the back polarizer 15 and the FPC board 18 for LC driving in vacuum (preferably under lower than 10 Pa) (attachment step). By this step, the substantially entire surfaces of the parallax barrier 20 and the panel 10 can be attached to each other. The panel 10 and the barrier 20 may be attached to each other with an adhesive tape such as a double-faced tape arranged in a frame shape. In the above-mentioned case where the panel 10 and the barrier 20 are attached with the resin-containing adhesive 40, which is arranged to cover at least the display screen, an air layer between the parallax barrier 20 and the LC panel 10 is not present, which can suppress unnecessary reflection of ambient light and transmission light, possibly caused by the air layer. Thus, the display qualities of the device 100 can be improved. Further, in an alignment step mentioned below, an arrangement accuracy between the barrier 20 and the panel 10 can be improved, which leads to an improvement in display qualities in dial view mode. In addition, the distance between the two can be easily controlled. The resistances to vibration and shock of the device 100 can be also improved.

In this case, the end of the adhesive 40 extends beyond the display region 19 at least in each of the viewing directions. As a result, the display qualities can be improved at least in each of the viewing directions.

The viscosity of the adhesive 40 is appropriately determined and may be about 1000 mPa·s to 2000 mPa·s (=cP) at 25° C., for example. The amount of the adhesive 40, and the pressure to the barrier 20 and the pressure time are appropriately determined, preferably. This can control the distance between the panel 10 and the barrier 20 to a desired value.

The FPC board 18 is bonded to terminals of the TFT array 11 by thermal compression through an anisotropic conductive film (ACF, not shown), thereby being connected to the wirings of the TFT array substrate 11.

The LC cell of the LC panel 10 is not especially limited. Examples thereof include TN (twisted nematic), IPS (in plane switching), and VATN (vertical alignment twisted nematic) LC cells. The panel 10 may be a multi-domain panel. The panel 10 may be a transmissive, reflective, or transflective panel. The panel 10 may be a passive matrix panel.

Then, alignment markers (not shown) of the display panel 10 and the parallax barrier 20 are used to adjust the horizontal position of the barrier 20 relative to the panel 10 by a position-adjusting member such as chuck, thereby arranging the panel 10 and the barrier 20 at predetermined positions (alignment step).

Then, referring to FIG. 5-3(i), light such as TV ray 73 is radiated to the entire adhesive 40 from the above with the barrier 20 fixed by the position-adjusting member, thereby curing the adhesive 40 (photoirradiation step). Thus, if the adhesive 40 contains a photocurable resin, particularly, a UV-curable resin, the barrier 20 can be easily bonded to the panel 10 with the two controlled in high accuracy. If a thermosetting resin adhesive is used as the adhesive 40, this photoirradiation step can be omitted.

The distance from a light output surface (the LC layer 13 side-surface of the CF substrate 12) from the adhesive 40 side-surface of the parallax barrier 20 may be appropriately determined in accordance with the size and pitch of the pixel. The distance is about 0.1 mm if the pitch and width of the pixel (sub-pixel in color display) are 65 μm and 40 μm, respectively. Substrates commonly used in display devices, for example, a glass substrate typically have a thickness of about 0.7 mm. The CF substrate 12 on the barrier 20 side of the panel 10 is typically thinned, preferably. It is preferable that the insulating substrate constituting the CF substrate 12 is thinned to have a thickness of 0.1 mm or smaller by glass etching and the like. Thus, if the display device 100 includes the barrier 20, the panel distance needs to be so small. In the present Embodiment, this panel distance can be controlled with a high accuracy because a resin adhesive (preferably, a photocurable resin adhesive) is used as the adhesive 40.

Then, if necessary after the transparent protective film is separated, the front polarizer 14 is attached to the protective film 32. Thus, the module is completed. In this case, the front polarizer 14 is preferably arranged to cover the adhesive 40. As a result, display qualities in the entire surface of the display region 19 can be improved in each of the viewing directions.

This module is assembled with a backlight unit, a case, and the like to complete the display device 100 of the present Embodiment. A backlight unit is not needed typically if a reflective LC panel is used as the panel 10.

The backlight unit includes common components such as a light source, a reflector, and optical sheets. The backlight unit may be a direct type or edge-light type one.

A modified example of the present Embodiment is mentioned below.

FIG. 6 is a cross-sectional view schematically showing the display device of a modified example of Embodiment 1.

In the display device 100 of the present Embodiment, as shown in FIG. 6, the transparent electrode 31 may be arranged on a back face side of the insulating substrate 21 constituting the parallax barrier 20, and further, the protective film 32 may be arranged on a back face side of the transparent electrode 31.

In this case, the transparent electrode 31 region and the front polarizer 14 region are preferably the same as shown in FIG. 4.

This embodiment can be easily provided by arranging the transparent electrode 31 and the protective film 32 on the barrier 22 side-surface of the insulating substrate 21, in the same manner as shown in FIGS. 5-1 to 5-3.

According to the embodiment in which the transparent electrode 31 is arranged on the front face side of the insulating substrate 21, as shown in FIG. 1, the distance between the transparent electrode 31 and the contact surface can be reduced and the sensitivity of the touch panel function can be improved.

According to the embodiment in which the transparent electrode 31 is arranged on the back face side of the insulating substrate 21, as shown in FIG. 6, the transparent electrode 31 and the barrier 22 can be both formed on one main surface side of the insulating substrate 21. So only one main surface of the insulating substrate 21 is treated, thereby producing the parallax barrier 20. This embodiment is advantageous in production. The attachment face of the front polarizer 14 is the insulating substrate 21, and so the panel before attachment of the front polarizer 14 can be easily cleaned.

If the transparent electrode 31 is arranged on the back face of the insulating substrate 21, it is preferable that the transparent electrode 31 is formed and then the barrier 22 is formed. Specifically, it is preferable that the transparent electrode 31 is arranged on the insulating substrate 21 side of the barrier 22. In this case, disconnection of the transparent electrode 31 at a shoulder portion of the barrier 22 can be suppressed, and so electrical conduction defects of the transparent electrode 31 can be suppressed.

FIG. 9 is a cross-sectional view schematically showing the display device of another modified example of Embodiment 1.

The parallax-creating member in the display device of the present Embodiment is not especially limited to the barrier 20. Used may be a lenticular lens array composed of semicircular column lenticular lenses 24 arrayed in the column direction of the pixels (sub-pixels) on the front face side of the substrate 21 as shown in FIG. 9. In this case, the transparent electrode 31 and the protective film 32 are arranged on the back face side of the substrate 21, for example. Also according to this configuration, error of parallax can be minimized.

Instead of the panel 10, the display device 100 of the present Embodiment may include, as the image-displaying member, a flat panel display (FPD) panel such as an organic EL display panel, a plasma display panel (hereinafter, also referred to as a “PDP”), a field emission display panel (hereinafter, also referred to as a “FED”). Specifically, the display 100 may be a self-emitting FPD such as an organic EL display, a POP, and a FED. Particularly preferably, the display device 100 is a LCD device or an organic EL display. Thus, the display device 100 of the present Embodiment can be preferably used as a multiple image display device with screen input function. The backlight 50 is not needed if the display device 100 is a self-emitting device.

The image-displaying member of the display device 100 is not especially limited as long as the display region is constituted by pixels arrayed in a matrix pattern, but preferably is a display panel as mentioned above.

The display panel means an optical element including a display element between a pair of substrates and electrically generating or controlling light by the display element. For example, LCD panels are optical elements typically including substrates disposed with a LC layer therebetween and electrically controlling a transmission and/or reflection amount of light by the LC layer.

The display element means an element having a light-emitting or light-adjusting function (optical shutter). For example, LCD panels typically include a display element with a light-adjusting function between a pair of substrates. More specifically, the LCD panels can typically show a light-adjusting function by changing a voltage applied to electrodes on the substrates, thereby changing alignment directions of LCs interposed between the substrates.

If the display device 100 includes an organic EL panel as the image-displaying member, the organic EL panel may include a display element including electrodes, an organic thin film containing a light-emitting material, and the like, instead of the display element containing LCs.

If the display device 100 includes a PDP panel as the image-displaying member, the PDP panel may include a display element including electrodes, dielectrics, rare gases, fluorescent substances, and the like, instead of the display element containing LCs.

If the display device 100 includes a FED panel as the image-displaying member, the FED panel may include a display element including microchips, gate electrodes, fluorescent substances, and the like, instead of the display element containing LCs.

The present application claims priority to Patent Application No. 2007-308656 filed in Japan on Nov. 29, 2007 under the Paris Convention and provisions of national law in a designated State, the entire contents of which are hereby incorporated by reference.

### BRIEF DESCRIPTION OF DRAWINGS

FIG. 1 is a cross-sectional view schematically showing the display device of Embodiment 1.

FIG. 2 is a plan view schematically showing the LCD panel of Embodiment 1.

FIG. 3 is a plan view schematically showing a configuration on the front face side of the parallax barrier of Embodiment 1

FIG. 4 is a plan view schematically showing a configuration near the corner of the display device of Embodiment 1.

FIGS. 5-1(a) to 5-1(d) are cross-sectional views schematically showing the display device of Embodiment 1 in the first production steps.

FIGS. 5-2(e) to 5-2(g) are cross-sectional views schematically showing the display device of Embodiment 1 in the second production steps.

FIGS. 5-3(h) and 5-3(i) are cross-sectional views schematically showing the display device of Embodiment 1 in the third production steps.

FIG. 6 is a cross-sectional view schematically showing the display device of a modified example of Embodiment 1.

FIGS. 7(a) and 7(b) are cross-sectional views schematically showing a structure of a conventional electrostatic capacity coupling type touch panel.

FIGS. 8(a) and 8(b) are cross-sectional views schematically showing a structure of a conventional dual view LCD device including an electrostatic capacity coupling type touch panel.

FIG. 9 is a cross-sectional view schematically showing the display device of another modified example of Embodiment 1.

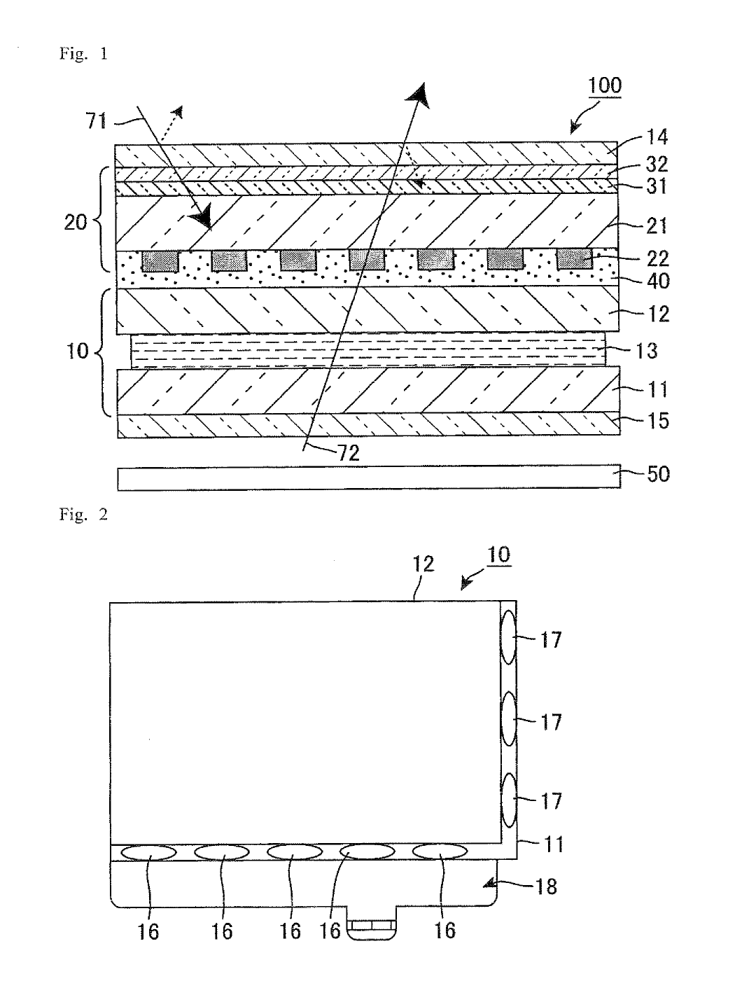

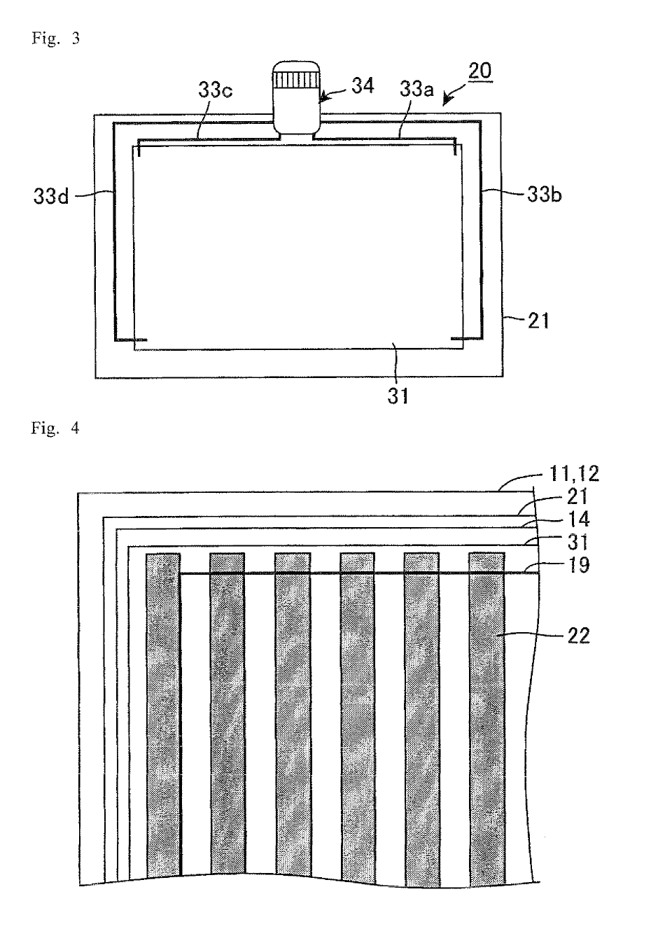

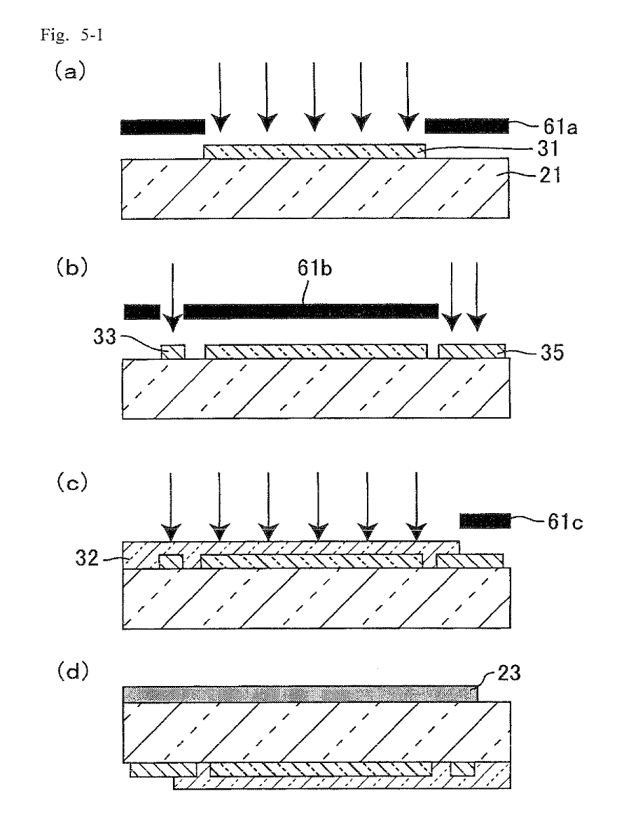

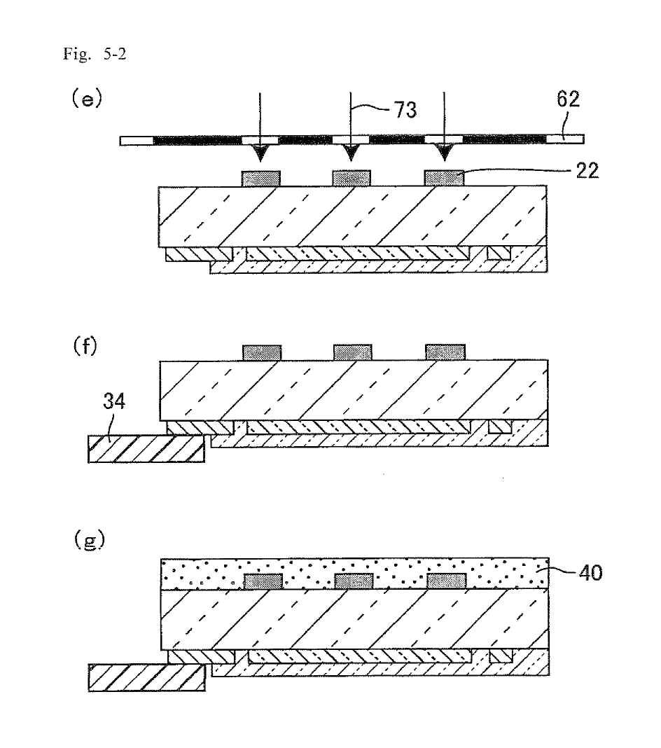

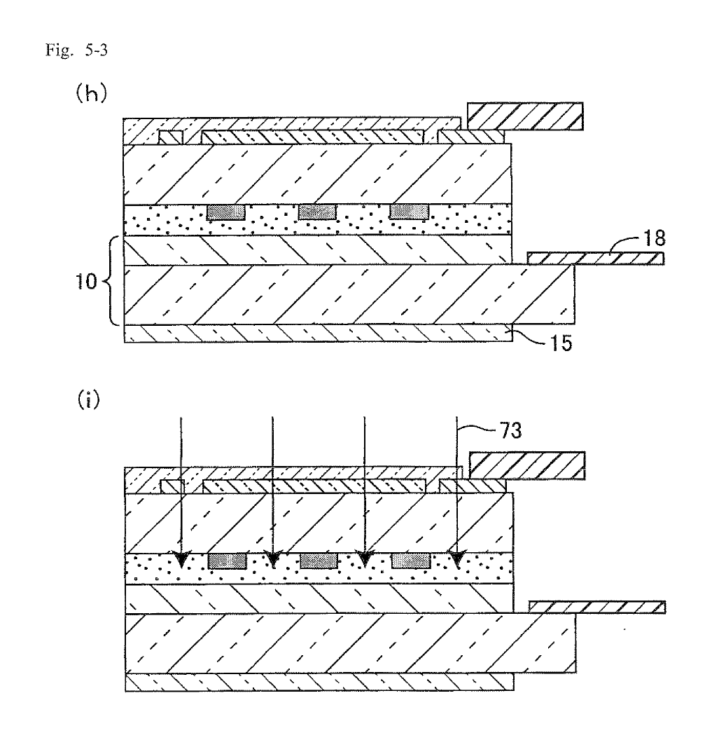

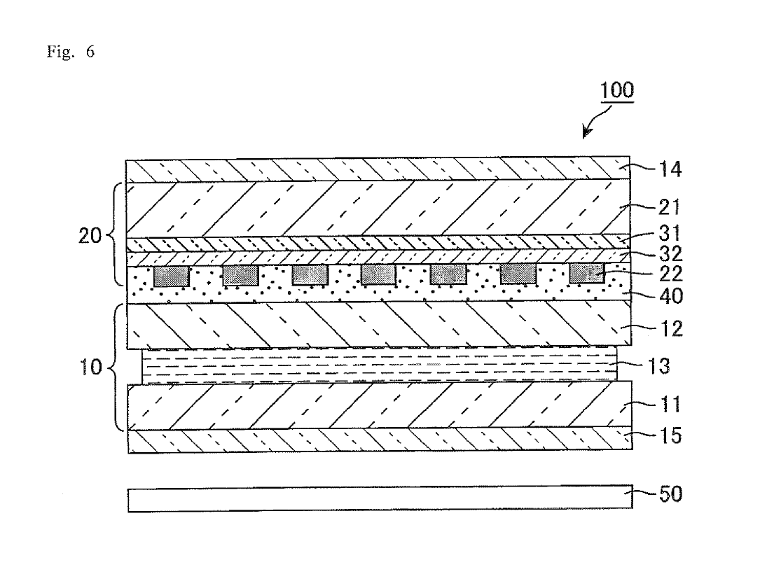

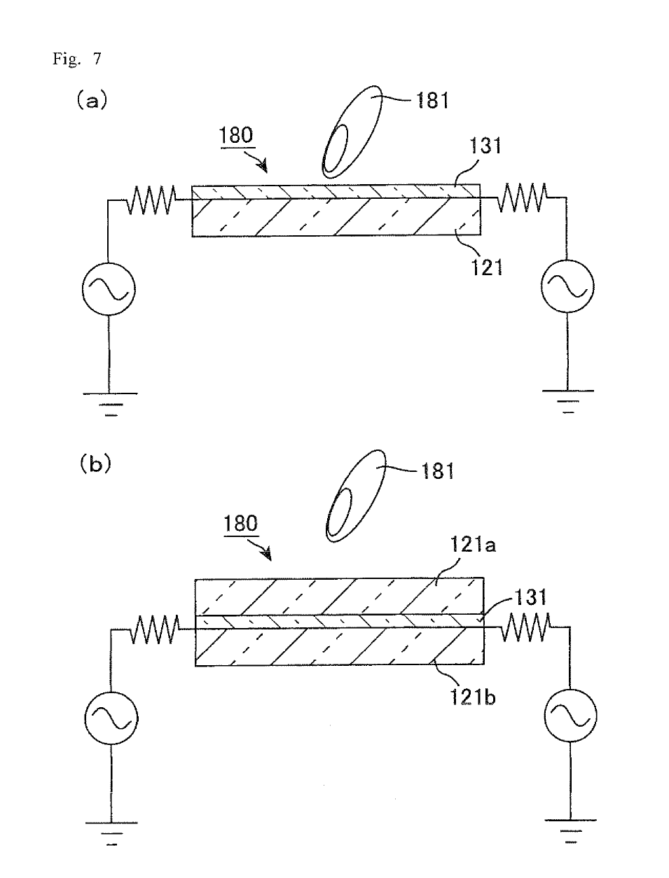

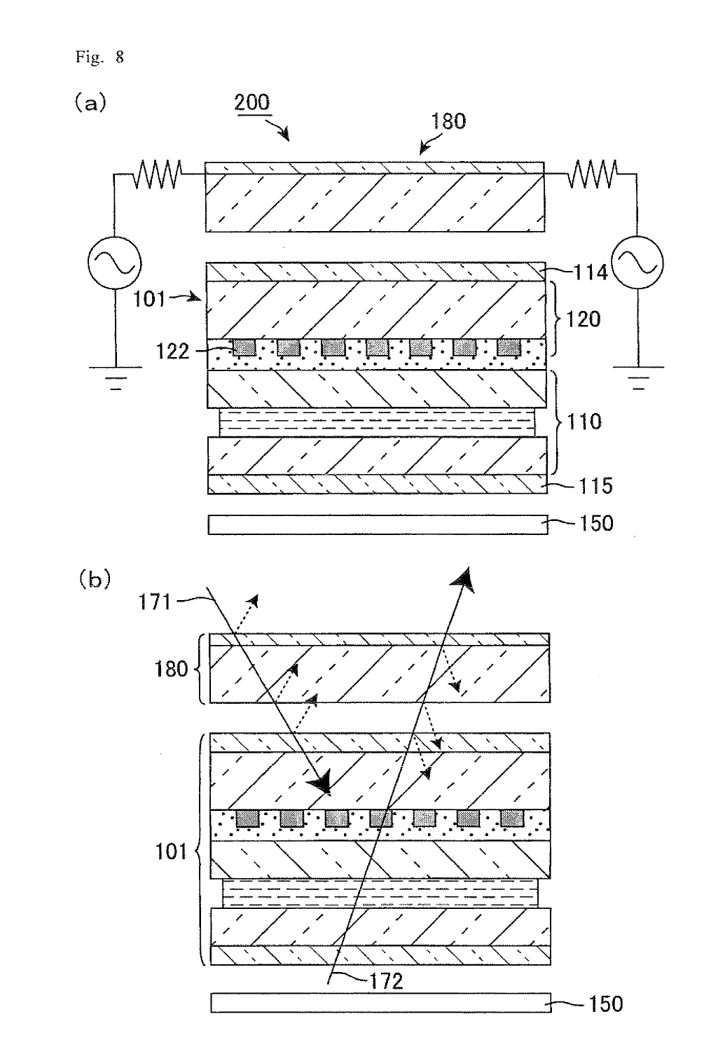

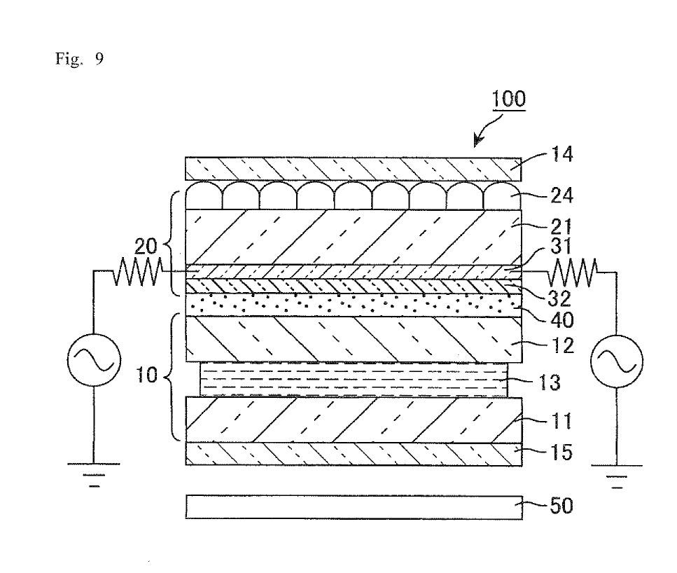

### EXPLANATION OF NUMERALS AND SYMBOLS

10, 110: Liquid crystal display panel (image-displaying member)
11: TFT array substrate
12: CF substrate
13: Liquid crystal layer
14, 114: Front polarizer
15, 115: Back polarizer
16: Source driver
17: Gate driver
18: FPC board for LC driving
19: Display region
20, 120: Parallax barrier (parallax-creating member)
21: Insulating substrate (substrate)
22, 122: Barrier
23: Black resin film
24: Lenticular lens
31, 131: Transparent electrode
32: Protective film
33, 33a, 33b, 33c, 33d: Touch panel wiring
34: FPC board for touch panel driving
35: Terminal portion
40: Adhesive
50, 150: Backlight
61a, 61b, 61c: Mask for deposition
62: Photomask
71, 171: Ambient light
72, 172: Transmission light
73: UV ray
100: Display device
101: Dual-view LCD panel
121, 121a, 121b: Glass substrate
80: Touch panel
181: Finger
200: Dual-view LCD device

1. A display device displaying images different depending on viewing directions simultaneously and detecting a position of a contact point on a display screen,
the display device comprising:
an image-displaying member displaying the images;
a parallax-creating member arranged on a front face side of the image-displaying member; and
a transparent electrode for detecting the position of the contact point,
wherein the parallax-creating member includes a substrate and a parallax element formed on the substrate,
the parallax element creating parallax in each of the viewing directions, and
the transparent electrode is formed on the substrate.

2. The display device according to claim 1,
wherein the transparent electrode is arranged on the front face side of the substrate.

3. The display device according to claim 1,
wherein the transparent electrode and the parallax element are arranged on the same main surface side of the substrate.

4. The display device according to claim 3,
wherein the parallax-creating member is a parallax barrier including a barrier composed of a light-shielding slit as the parallax element, and
the transparent electrode is arranged on a substrate side of the barrier.

5. The display device according to claim 1,
wherein an end of the transparent electrode extends beyond an end of the display region at least in each of the viewing directions.

6. The display device according to claim 5,
wherein the image-displaying member is a liquid crystal display panel including a pair of substrates and a liquid crystal layer interposed therebetween,
the display device includes a front polarizer arranged on the front face side of the parallax-creating member, and
the front polarizer is arranged to cover the transparent electrode.

7. The display device according to claim 1,
wherein the parallax-creating member is a parallax barrier including a barrier composed of a light-shielding slit as the parallax element, and
the barrier is arranged on a back face side of the substrate.
